(19) United States
(12) Patent Application Publication
(10) Pub. No.: US 2002/0167479 A1
(43) Pub. Date: Nov. 14, 2002

(54) High performance reflective liquid crystal light valve using a multi-row addressing scheme

(75) Inventors: Peter J. Janssen, Briarcliff Manor, NY (US); Remus L. Albu, Briarcliff Manor, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/853,940

(22) Filed: May 10, 2001

(51) Int. Cl. G09G 3/36

(52) U.S. Cl. 345/103

(57) ABSTRACT

A system for partitioning a column in a liquid crystal display (LCD) into n sub-columns, wherein each sub-column drives 1/n of the total cells associated with the column, thereby reducing the current required to drive the columns. By increasing the number of column drivers and associated column conductors in the LCD, the capacitive loading on each column driver is proportionately reduced, thereby enabling the use of smaller-area, and thus less expensive column driver devices. The LCD rows can be arranged in groups to provide 1/n “effective” rows, wherein each row driver drives n-sub columns.

### FIELD OF THE INVENTION

This invention relates to the field of liquid crystal displays (LCDs), and more particularly to a method for driving columns and rows in LCDs.

### BACKGROUND OF THE INVENTION

In liquid crystal displays (LCDs), a matrix of picture elements (pixels) or cells arranged in rows and columns are activated by a matrix of row and column drivers. In a typical display sequence, a multitude of column drivers are each loaded with an analog display value for a particular cell, and a row driver is then selected to enable an entire row. The columns are collectively pulsed by a bulk current source to impress the particular values on the associated cells. Both row and column drive signals are then removed and the operation is repeated for a next row of cells.

Due to an intrinsic capacitance that is associated with each cell, each column driver must drive the collective capacitance of all the cells of that column in addition to parasitic capacitances associated with neighboring columns. Switching voltages across such a capacitance requires that the column drivers have a robust current carrying capability. Since the area of a driver device is directly proportional to that current, conventional drive schemes are limited to medium resolution displays having a color depth of 24 bits per pixel at a 120 Hz frame rate. A drawback of conventional driver architectures is that they are inadequate to drive higher performance displays, such as color-sequential displays.

### SUMMARY

In a preferred embodiment of the present invention, a liquid crystal display (LCD) column is partitioned into n sub-columns, where each sub-column drives 1/n of the total cells associated with the column in order to reduce the current requirements on the sub-column drivers. The number of conductors in the LCD is increased, with n conductors being required for a single column, wherein one conductor is associated with each sub-column. LCD Rows are correspondingly arranged in groups to provide 1/n “effective” rows, wherein each row driver drives n sub-columns. This arrangement allows the integrated column drivers to be significantly smaller in area than would otherwise be possible.

### BRIEF DESCRIPTION OF THE DRAWINGS

FIG. 1 shows a schematic diagram of a driver configuration used in a conventional liquid crystal display (LCD).

FIG. 2 shows a schematic diagram of an LCD row and column driver configuration according to a preferred embodiment of the present invention.

FIG. 3 shows a schematic diagram of an LCD driver configuration according to an alternate embodiment of the present invention.

### DETAILED DESCRIPTION OF THE INVENTION

In high resolution, high color-depth liquid crystal displays (LCDs), capacitances that are associated with the picture elements (pixels) and cells of the LCD create significant loading requirements on the row and column integrated driver devices. These loading effects limit the size and resolution of LCDs that are attainable using conventional LCD active matrix architectures.

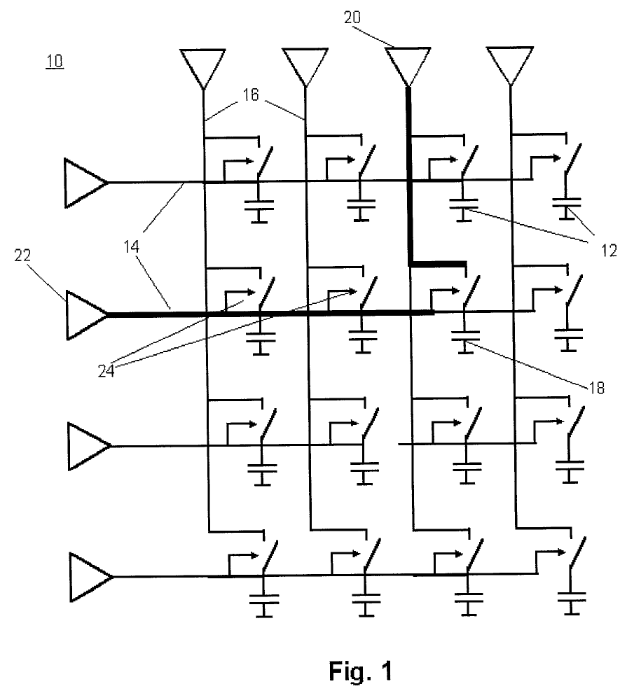

FIG. 1 shows a schematic diagram of a driver configuration 10 used in a conventional liquid crystal display (LCD) having an X-Y matrix of cells 12, each cell being defined by an intersection of a row conductor 14 and a column conductor 16. To display a particular cell 18 in the matrix, a particular column driver device 20 is pre-loaded with a unique video data value which has been previously stored in a memory device. Row driver 22 is then activated, for example, by clamping gates of the row devices to a ground rail, to enable the gates of all cell switching devices 24 along the particular row conductor 14 while the column driver 20 is activated based on the pre-loaded value. Cell 18, along with an associated column capacitance, is then charged to a predetermined voltage, thus causing the cell to be displayed.

This column capacitance is the cumulative cell, or pixel, capacitance seen by a column driver 20 and can be represented by the equation

C_{column}=ΣC_{cell}+ΣC_{parasitic} [1]

where C_{column} is the total capacitive load that a column driver must switch, C_{cell} is the primary capacitance at each X-Y intersection of the column, and C_{parasitic} is the capacitance between each column conductor 16 and an adjacent parallel column conductor 16. For high resolution matrices, this total capacitance, C_{column}, often becomes large, thus requiring more current and attendant larger area devices 20 at each column.

Another drawback of conventional architecture 10 shown in FIG. 1 is that only a single row conductor can be addressed at any instant in time, which places severe limitations on the number of rows that can be processed in a given frame time interval. This frame time interval is a function of the data update requirements of a video display, and for a given frame refresh rate, such as 60 Hz, or a 16.67 milliseconds period, an increase in the number of rows proportionately reduces the amount of “dwell” time available for each row. To charge a given C_{column} to a same voltage in this shorter “dwell” time requires a proportional increase in an applied drive current. Thus, to increase the number of rows requires a column driver device 20 that has higher speed and higher current capability than a driver device 20 for a lower resolution display. To overcome these drawbacks, a system for partitioning a column into sectors can significantly reduce the loading effects that are seen by an individual column driver while allowing the activation of multiple rows at a time.

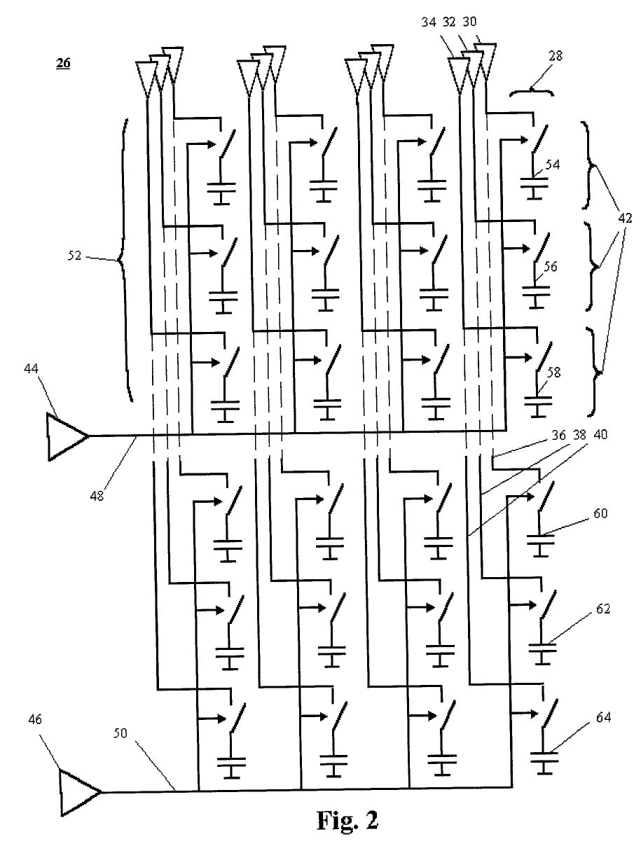

FIG. 2 shows a schematic diagram of an LCD row and column driver configuration 26 according to a preferred embodiment of the present invention. Each column 28 is divided into a number of partitions n. A corresponding column driver 30, 32, and 34 and column panel conductor 36, 38, and 40, respectively, are connected to each one of these partitions.

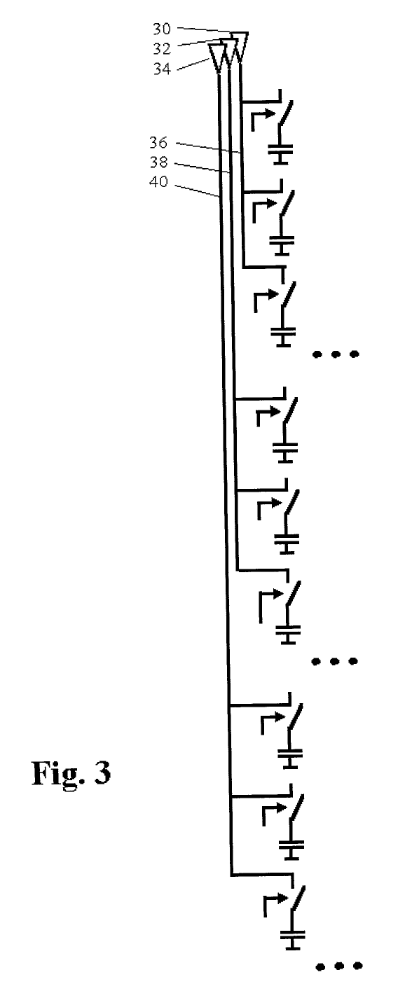

For an exemplary partitioning scheme where n=3, each column driver 30, 32, and 34 will drive ⅓ of the cells in a column 28. This provides for a ⅔ reduction in the capacitive loading on each of the column drivers 30, 32, and 34, and an attendant ⅔ cross-sectional area reduction in each device as compared to columns having no partitions. Such an area reduction leads to increase in silicon manufacturing yields, and thus lower costs per driver device. This partitioning can be implemented in a variety of ways. For example, partitioning can provide that every third cell is in a same exemplary partition as shown in FIG. 2, or in an alternative exemplary embodiment the cells of each partition can be contiguous as shown in FIG. 3. The practical loading effects will be the same in either case. A further advantage of the exemplary partitioning is that the column “settling time” is increased by a factor of three.

Selection of the integer n is solely dependent on available integration technologies and the size of the desired LCD. The configuration of the present invention is scalable, and the LCD size is limited only by the current-carrying capacity of the panel conductors. However, it should be noted that the number of parallel conductors required to represent each column has practical limitations since higher current-carrying capacity conductors have to be fabricated from a solid material rather than from a variety of lower current-carrying capacity transparent materials, such as compounds that include Indium and Tin.

Referring again to FIG. 2, rows 42 can be independently partitioned to achieve results similar to the partitioned columns and produce relaxation of specific performance requirements on row drivers 44 and 46 and row conductors 48 and 50, respectively. An exemplary reverse partition 52 is shown in FIG. 2, which includes all the cells 12 and 18 that are electrically coupled to row conductor 48. Since each column driver 30, 32, and 34 drives smaller loads (⅓ of a single column load in the present example as compared to columns that are not partitioned), each row driver 46 and 48 can now drive 3 columns simultaneously at a same driver current capability as conventional LCD rows shown in FIG. 1.

An exemplary sequence for driving the cells shown in FIGS. 2 and 3 includes the following steps: at step 1, data values are loaded into column drivers 30, 32, and 34; at step 2, row driver 44 is activated to charge cells 54, 56, and 58, respectively; at step 3, the row and column drivers are disabled; at step 4, data values are loaded into column drivers 30, 32, and 34 for the next row of cells along conductor 50; at step 5, row driver 46 is activated to charge cells 60, 62, and 64, respectively; and at step 6 row and column drivers are disabled.

As discussed above, each column driver requires only ⅓ of a row time period due to the lesser loading and settling time required of each column partition. This allows 3 times the number of row periods over that of the prior art, and 3 times the LCD resolution. Note that the sequence described above represents the steps required to activate only a small portion of total cells, rows, and columns of an LCD. The reduced structures shown in FIGS. 2 and 3 are presented solely for simplifying the explanation and is not intended to represent restrictions or limitations on the scope of the present invention.

It can be appreciated by one skilled in the art, that the means for connecting the row and column drivers to the row and column conductors can include: 1) all conductors connecting at a same edge of the LCD panel, with the conductors running parallel until they reach a breakout point for each individual partition; 2) an exemplary half of the conductors being connected on one edge of the LCD, and the other half being connected on an opposite edge of the LCD, wherein the two conductors abut without contact in the center of the LCD display area; and 3) a combination and/or variations of the two techniques. The principal limitation on such a design is the amount of parasitic capacitance that accumulates due to adjacent parallel conductors.

Although the foregoing discussion addressed a practical sequential row selection scheme, it should be understood that both conventional LCDs and the novel applications of the present invention can be implemented in other ways. For example, single X-Y addressing of a cell may occur in any random order under the direction of a driver controller, rather than by a full display row 18 or 22. Alternatively, columns or groups of columns rather than rows can be sequenced as desired for a particular application. The only criteria for activating a cell is that the two complementary switches associated with an X-Y intersection be activated together.

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the invention. Details of the embodiments may be varied without departing from the spirit of the invention, and the exclusive use of all modifications which come within the scope of the appended claims is reserved.

What is claimed is:

1. A system for driving a liquid crystal display (LCD) having a plurality of display cells arranged in a plurality of rows and a plurality of columns, comprising:
a plurality of row conductors;
a row-driving means for selectively activating the row conductors;
a partitioning means for dividing each plurality of cells associated with a unique LCD column into a plurality of partitions;
a plurality of column conductors arranged orthogonal to the row conductors, wherein each column conductor is associated with a unique one of the plurality of partitions;
a column-driving means for selectively activating the column conductors; and
a controlling means for operationally controlling the row and column driving means.

2. The system according to claim 1, wherein the number of row conductors is equal to the number of LCD display rows.

3. The system according to claim 2, wherein the row-driving means comprises a plurality of row drivers, wherein each row driver is connectively coupled to a plurality of row conductors.

4. The system according to claim 3, wherein each row driver is connectively coupled to at least two row conductors.

5. The system according to claim 1, wherein the plurality of conductors associated with the plurality of partitions of each column of the LCD are adjacent and parallel to one another, each one of the plurality of conductors terminating at a same edge of the LCD.

6. The system according to claim 1, wherein each column has two partitions.

7. The system according to claim 6, wherein the column conductors associated with the two partitions terminate at opposing edges of the LCD, each conductor traversing one half of the column of the LCD.

8. A method for driving a liquid crystal display (LCD) having a plurality of cells arranged in rows and columns, comprising the steps of:
a) loading data into a plurality of column drivers;
b) activating a first row-driving means for a first one of a plurality of rows;
c) activating a first one of a plurality of column-driving means to display at least one cell from a first column partition that is located at an intersection with the activated row;
d) activating a different one of the plurality of column-driving means to display at least one cell of another column partition that is located at an intersection with the activated row;
e) repeating step d) for each remaining partition;
f) deactivating the row and column driving means; and
g) repeating steps a) through f) for a another one of the plurality of rows.

9. The method according to claim 8, wherein the data is loaded into the plurality of column drivers from a memory device.

10. The method according to claim 8, wherein the row driving means is activated by turning on a switch which connectively couples a row conductor to a ground potential.

11. The method according to claim 8, whereby activating the column driving means comprises the steps of:
a) applying a current signal to a plurality of activated column drivers; and
b) terminating the applied current signal at each column driver when a voltage across each LCD cell rises to a predetermined magnitude.
